(19) United States
(12) Patent Application Publication
(10) Pub. No.: US 2012/0099888 A1
(43) Pub. Date: Apr. 26, 2012

(54) IMAGE FORMING APPARATUS AND OPENING/CLOSING DEVICE

(75) Inventors: Kazuyuki OHGI, Yokohama-shi (JP); Norio IRIE, Yokohama-shi (JP); Kazuhiro TOBITA, Yokohama-shi (JP); Mitsuyuki ISHIDA, Yokohama-shi (JP)

(73) Assignee: FUJI XEROX CO., LTD., Tokyo (JP)

(21) Appl. No.: 13/084,008

(22) Filed: Apr. 11, 2011

(30) Foreign Application Priority Data
Oct. 25, 2010 (JP) 2010-238342

(51) Int. Cl. G03G 15/00

(52) U.S. Cl. 399/107

(57) ABSTRACT

An image forming apparatus includes: an image forming apparatus main body; an ejection portion; a structure; a mounting mechanism; and a supporting member. The image forming apparatus main body has a cutout continuous with a space, the cutout being formed in such a manner as to straddle a surface of the image forming apparatus main body on a side thereof on which a recording medium is retrieved from the ejection portion and a surface of the image forming apparatus main body on one side thereof in a direction of a rotary shaft. An end of the supporting member being located at a position more distant than one end from the surface of the image forming apparatus main body on the side thereof on which the recording medium is retrieved from the ejection portion, in a state in which the structure is located in a second position.

### CROSS-REFERENCE TO RELATED APPLICATION

This application is based on and claims priority under 35 USC 119 from Japanese Patent Application No. 2010-238342 filed Oct. 25, 2010.

### BACKGROUND

### Technical Field

The present invention relates to an image forming apparatus and an opening/closing device.

### SUMMARY

According to an aspect of the present invention, there is provided an image forming apparatus including: an image forming apparatus main body; an ejection portion that is provided on an upper surface of the image forming apparatus main body and receives a recording medium; a structure that is disposed above the image forming apparatus main body, with a space formed between the structure and the ejection portion; a mounting mechanism that mounts the structure on the image forming apparatus main body in such a manner as to allow the structure to pivotally move about a rotary shaft with respect to the image forming apparatus main body and to allow the structure to be movable between a first position at which the structure is supported from below by an upper surface of the image forming apparatus main body and a second position at which the space is expanded; and a supporting member that supports from below the structure located in the second position and has one end mounted to the structure and another end mounted to the image forming apparatus main body, the image forming apparatus main body having a cutout continuous with the space, the cutout being formed in such a manner as to straddle a surface of the image forming apparatus main body on a side thereof on which the recording medium is retrieved from the ejection portion and a surface of the image forming apparatus main body on one side thereof in a direction of the rotary shaft, the other end of the supporting member is located at a position more distant than the one end from the surface of the image forming apparatus main body on the side thereof on which the recording medium is retrieved from the ejection portion, in a state in which the structure is located in the second position.

### BRIEF DESCRIPTION OF THE DRAWINGS

An exemplary embodiment of the present invention will be described in detail based on the following figures, wherein:

FIG. 1 is a sectional view taken from the right-hand side of an image forming apparatus according to an exemplary embodiment of the present invention;

FIG. 2 is a cutaway view taken from the right-hand side of the image forming apparatus illustrated in FIG. 1;

FIGS. 3A to 3C illustrate an image forming apparatus main body included in the image forming apparatus shown in FIG. 1, wherein FIG. 3A is a left side view, FIG. 3B is a front elevation, and FIG. 3C is a right side view;

FIG. 4 is a perspective view of the image forming apparatus shown in FIG. 1;

FIG. 5 is a sectional view of a document reading device included in the image forming apparatus shown in FIG. 1 taken along the arrowed line A-A of FIG. 1;

FIG. 6 is a sectional view of the document reading device shown in FIG. 5 taken along the arrowed line B-B of FIG. 1;

FIG. 7 is a diagram illustrating a guide member attached to the document reading device shown in FIG. 5;

FIG. 8 is a perspective view of a shock absorber included in the image forming apparatus shown in FIG. 1, in a state in which the document reading device is open with respect to the image forming apparatus main body; and

FIG. 9 is a perspective view of the shock absorber shown in FIG. 8, in a state in which the document reading device is closed with respect to the image forming apparatus.

### DETAILED DESCRIPTION

Next, an exemplary embodiment of the present invention will be described with reference to the accompanying drawings.

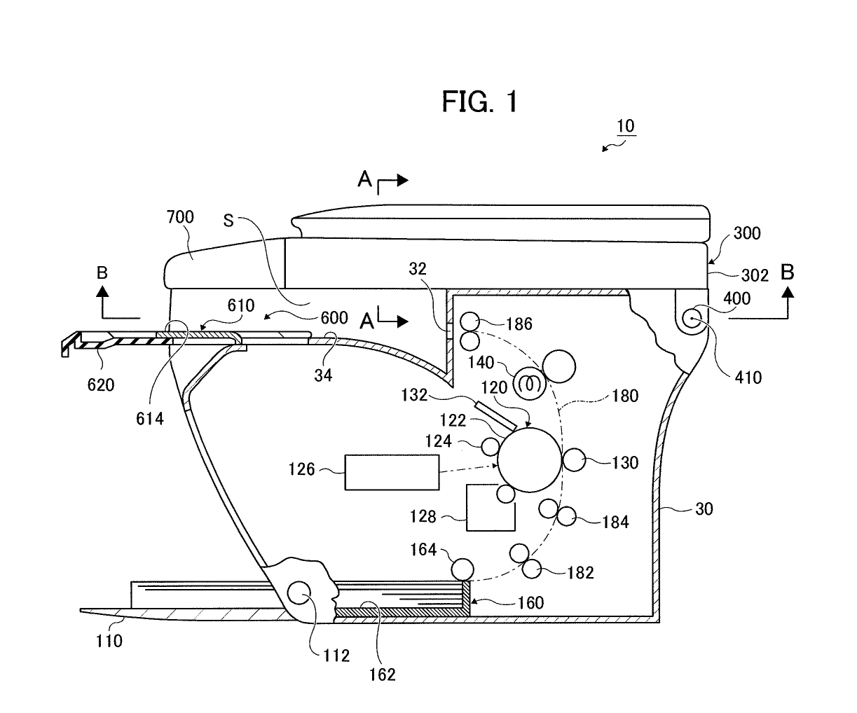

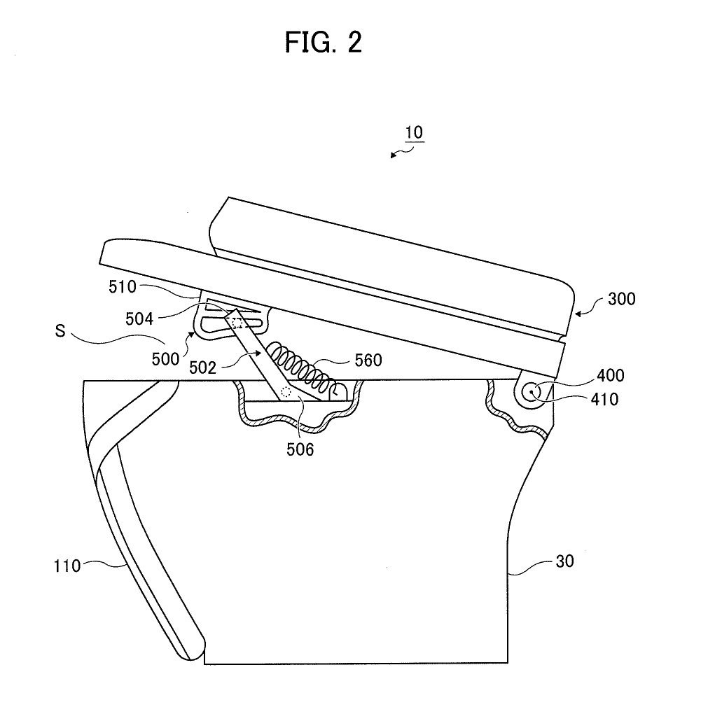

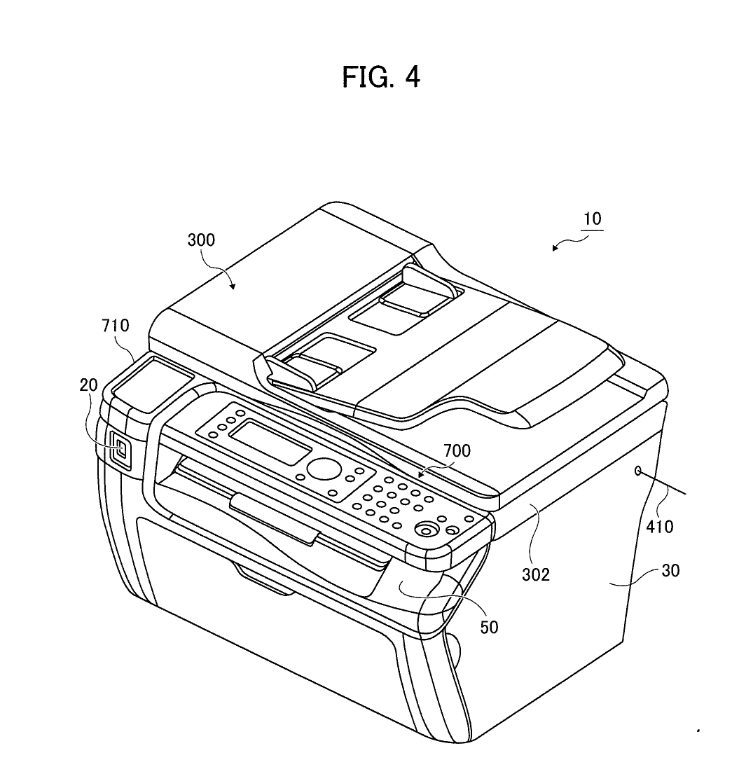

FIGS. 1 and 2 illustrate an image forming apparatus 10 according to the exemplary embodiment of the present invention. The image forming apparatus 10 includes: an image forming apparatus main body 30 serving as a first structure; an ejection portion 600, serving as an ejection portion that receives an ejected object, for receiving a recording medium; a document reading device 300 serving as a structure and also as a second structure; a hinge 400 serving as a mounting mechanism that mounts the document reading device 300 on the image forming apparatus main body 30; a shock absorber 500 having an arm member 502 serving as a supporting member, and a guide member 510 serving as a guide portion that guides the arm member 502; and a control panel 700 serving as an operating portion that is used to operate the image forming apparatus 10. Also, the image forming apparatus 10 includes a data input terminal for inputting image data from an external device such as a personal computer (see FIG. 4).

The image forming apparatus 10 forms an image on a paper sheet serving as a recording medium on the basis of image data read by the document reading device 300, and also on the basis of image data inputted through the data input terminal 20. Also, the image forming apparatus 10 can be connected, for example, to a telephone line, and forms an image on a paper sheet on the basis of image data inputted through the telephone line. Further, the image forming apparatus 10 transmits over the telephone line the image data read by the document reading device 300 and the data inputted through the data input terminal 20.

A paper-feed opening/closing portion 110 is provided on a front surface of the image forming apparatus main body 30. The paper-feed opening/closing portion 110 is mounted on the image forming apparatus main body 30 in such a manner to be openable and closable with a hinge 112. FIG. 1 shows an open state of the paper-feed opening/closing portion 110 with respect to the image forming apparatus main body 30, and FIG. 2 shows a closed state of the paper-feed opening/closing portion 110 with respect to the image forming apparatus main body 30. In addition, an ejection hole 32 that is used to eject a paper sheet with an image formed thereon is formed in the image forming apparatus main body 30.

An image forming portion 120 and a feeder 160 are mounted within the image forming apparatus main body 30. Also, a conveying path 180 is formed within the image forming apparatus main body 30. The image forming portion 120 includes: a photoreceptor drum 122 serving as an image holding body; a charging deice 124 that charges the surface of the photoreceptor drum 122; a latent image forming device 126 that forms a latent image on the surface of the photoreceptor drum 122 charged by the charging deice 124, by irradiating the surface of the photoreceptor drum 122; a developing device 128 that develops, with developer, the latent image formed on the surface of the photoreceptor drum 122 by the latent image forming device 126; a transfer device 130 that transfers to a paper sheet a developer image formed on the surface of the photoreceptor drum 122 by the image development performed by the developing device 128; a cleaning device 132 that cleans the developer remaining on the surface of the photoreceptor drum 122 after the transfer performed by the transfer device 130; and a fixing device 140 that fixes the developer image transferred to a paper sheet by the transfer device 130, onto the sheet.

The feeder 160 includes, for example, one sheet-storage portion 162 that stores a stack of paper sheets, and a feed roller 164 that feeds the sheets stored in the sheet storage portion 162. When a sheet of a size larger than a specified size is stored in the sheet storage portion 162, the paper-feed opening/closing portion 110 is made to be in an open state. In this case, a rear end of the sheet protrudes beyond the image forming apparatus main body 30 and is supported from below in the direction of gravity by the paper-feed opening/closing portion 110.

The conveying path 180 is a conveying path that is used to convey a paper sheet toward the transfer device 130 from the feeder 160 and further convey the sheet to the ejection portion 600. The foregoing feed roller 164, a conveying roller 182, a registration roller 184, the foregoing transfer device 130, the foregoing fixing device 140, and a discharge roller 186 are provided along the conveying path 180, in this order from the upstream in the sheet conveying direction.

The conveying roller 182 conveys a paper sheet to the registration roller 184. The registration roller 184 temporarily stops movement to the transfer device 130 of the front end of the sheet to be conveyed to the transfer device 130, and then restarts the movement to the transfer device 130 of the front end of the sheet according to a timing when the developer image formed on the photoreceptor drum 122 reaches the position corresponding to the transfer device 130. The discharge roller 186 conveys to the ejection portion 600 the sheet with the developer image fixed thereto by the fixing device 140.

The ejection portion 600 includes an extension portion 610 provided on an upper surface 34 of the image forming apparatus main body 30 and extendable from the surface 34 in a forward direction (the forward direction in FIG. 1) corresponding to the sheet ejection direction. The extension portion 610 includes a first extension member 614 extendable in the sheet ejection direction from the surface 34, and a second extension member 620 further extendable in the forward direction from the first extension member. The extension portion 610 supports, from below in the direction of gravity, a portion protruding beyond the surface 34 of the sheet with an image formed thereon.

The document reading device 300 includes a document reading device main body 302, and is disposed above the image forming apparatus main body 30 in such a manner as to form a space S between the document reading device 300 and the ejection portion 600.

The hinge 400 mounts the document reading device 300 on the image forming apparatus main body 30 in such a manner as to allow the document reading device 300 to pivotally move about a rotary shaft 410 with respect to the image forming apparatus main body 30. Also, the hinge 400 mounts the document reading device 300 on the image forming apparatus main body 30 in such a manner that the document reading device 300 is movable between a first position shown in FIG. 1 and a second position shown in FIG. 2. As used herein, the first position refers to a state in which the document reading device 300 is supported from below by the upper surface 34 of the image forming apparatus main body 30. The second position refers to a state in which the space S is expanded relative to the case where the document reading device 300 is located in the first position.

The shock absorber 500 is used to absorb the shock caused by pivotal movement about the rotary shaft 410 of the document reading device 300, and is disposed one by one on each of the right side (the near side in FIG. 2) and left side (the far side in FIG. 2) of the image forming apparatus 10. Of these two shock absorbers 500, the right shock absorber 500 is shown in FIG. 2, and the left shock absorber 500 is not shown. The right shock absorber 500 and the left shock absorber 500 have the same structure.

Each of the shock absorbers 500 includes, as described above, the arm member 502 and the guide member 510, and further includes a coil spring 560. The arm member 502 has one end 504 mounted to the document reading device 300 through the guide member 510 and the other end 506 mounted to the image forming apparatus main body 30. Further, the arm member 502 supports, from below, the document reading device 300 located in the second position (the position shown in FIG. 2). The guide member 510 is a member for guiding the arm member 502, and is provided on the document reading device 300. The coil spring 560 serves as a biasing member for urging the arm member 502. Further details of the shock absorbers 500 will be described later.

In the image forming apparatus 10, in a state in which the document reading device 300 is located in the first position, an operator may put his/her hand into the space S to retrieve the sheet ejected on the ejection portion 600. Alternatively, after moving the document reading device 300 to the second position to expand the space S, an operator may put his/her hand into the space S to retrieve the sheet ejected on the ejection portion 600. For example, in order to retrieve paper of a relatively small size such as postcards, from the ejection portion 600, it is necessary to put the hand into the back of the space S. Therefore, it is easier to retrieve the paper after moving the document reading device 300 to the second position to expand the space S than in the state in which the document reading device 300 is located in the first position.

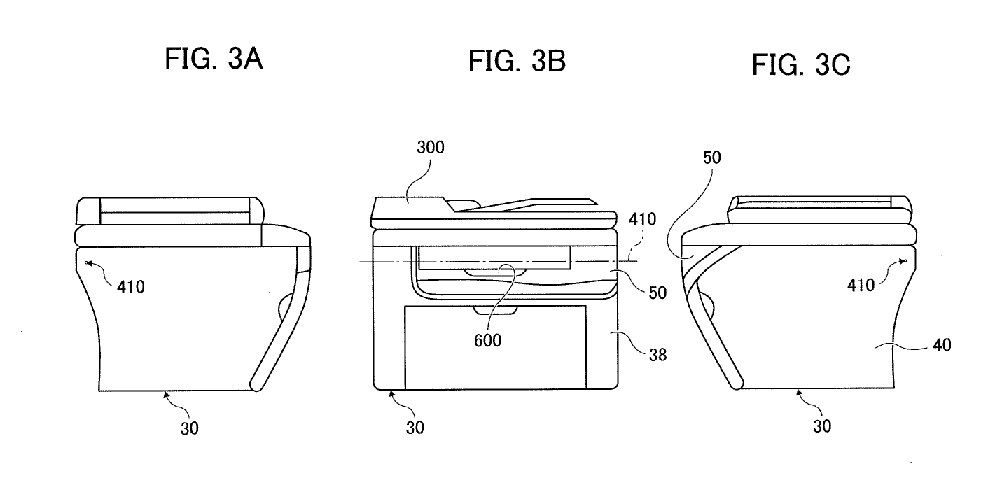

FIGS. 3A to 3C show the image forming apparatus main body 30. As shown in FIGS. 3B and 3C, a cutout 50 is formed in the image forming apparatus main body 30 in such a manner as to straddle a front surface 38 that is a surface of the image forming apparatus main body 30 on the side thereof on which paper sheets are retrieved from the ejection portion 600 and a right side surface 40 that is a surface of the image forming apparatus main body 30 on one side thereof in the direction of the rotary shaft 410. The cutout 50 is a space formed within the image forming apparatus main body 30 in a recessed manner in the front surface 38 and the right side surface 40. Also, the cutout 50 is continuous with the space S formed between the ejection portion 600 and the document reading device 300.

The cutout 50 is used to retrieve, toward the front surface 38, the sheet ejected on the ejection portion 600, by inserting, for example, the right hand into the space S through the cutout 50 from the side of the front surface 38 or the right side surface 40 to allow the right hand to reach the ejection portion 600. Also, the cutout 50 is used to pivotally move the document reading device 300 to the second position (see FIG. 2) by inserting, for example, the right hand into the space S through the cutout 50 from the side of the front surface 38 or the right side surface 40 to lift up from below the document reading device 300 located in the first position (see FIG. 1) with the right hand.

FIG. 4 is a perspective view of the image forming apparatus 10. As shown in FIG. 4, the control panel 700 includes pressing portions to be pressed at the time of inputting a facsimile destination number, starting image formation and the like. Also, the control panel 700 is attached to an upper surface of the document reading device 300, and disposed in front of the image forming apparatus 10. Further, the cutout 50 is located between the position of the control panel 700 on the document reading device main body 302 and the image forming apparatus main body 30. In addition, the control panel 700 is provided on the side of the document reading device 300 on which the cutout 50 is provided in the direction of the rotary shaft 410.

When the control panel 700 is operated by, for example, the right hand, the unused left hand might be put on the image forming apparatus 10. In the image forming apparatus 10 according to the exemplary embodiment of the present invention, the cutout 50 is located below the control panel 700, on the other hand, a left end 710 of the document reading device 300 on which the left hand is likely to be put is supported from below in the direction of gravity by the image forming apparatus main body 30.

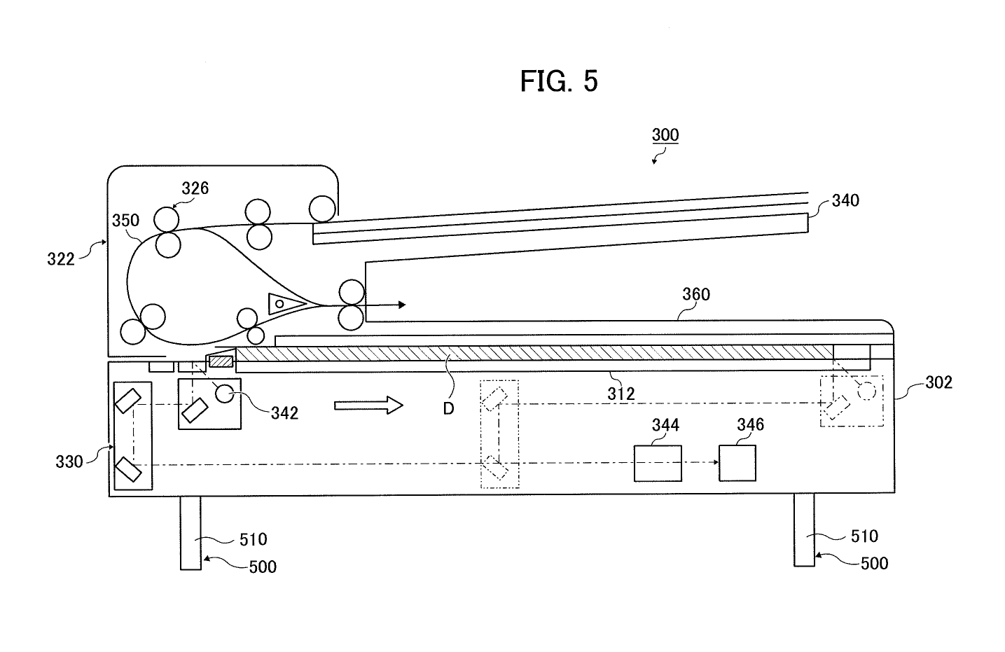

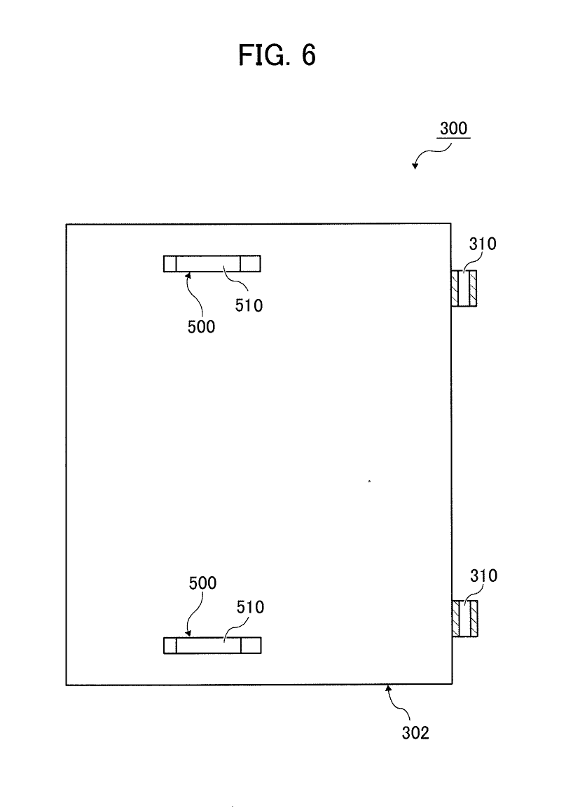

FIGS. 5 and 6 show the document reading device 300. The document reading device 300 includes, as described above, the document reading device main body 302. Also, a lower surface of the document reading device main body 302 is mounted with the respective guide members 510 of the foregoing right and left shock absorbers 500. Further, the document reading device main body 302 includes mounted portions 310 to be mounted to the image forming apparatus main body 30 by the foregoing hinges 400 (see FIGS. 1 and 2).

As shown in FIG. 5, the document reading device 300 also includes a platen member 312 made of a light transmissive material, and the document reading device main body 302 serves as a reading table on which a document is placed. Further, the document reading device main body 302 is mounted with a platen cover 322 that is openable and closable with respect to the document reading device main body 302.

A reader 330 that irradiates a document and reads the document on the basis of reflected light from the document of the irradiated light is mounted within the document reading device main body 302. A document conveying device 326 that automatically conveys a document D is mounted within the platen cover 322. The document reading device 300 has the function of scanning the document D in the process of being conveyed by the document conveying device 326, and the function of reading the document D placed on the platen member 312.

The document conveying device 326 includes a platen 340 for setting the document D to be scanned, a document conveying path 350 that conveys the document, and an ejection table 360 on which the document having been subjected to image scanning is ejected.

The reader 330 includes a light source 342, a lens 344, and a photoelectric conversion element 346. The light source 342 irradiates a document, and the lens 344 focuses reflected light from the irradiated document, and then the photoelectric conversion element 346 receives the focused light to convert the light to signals.

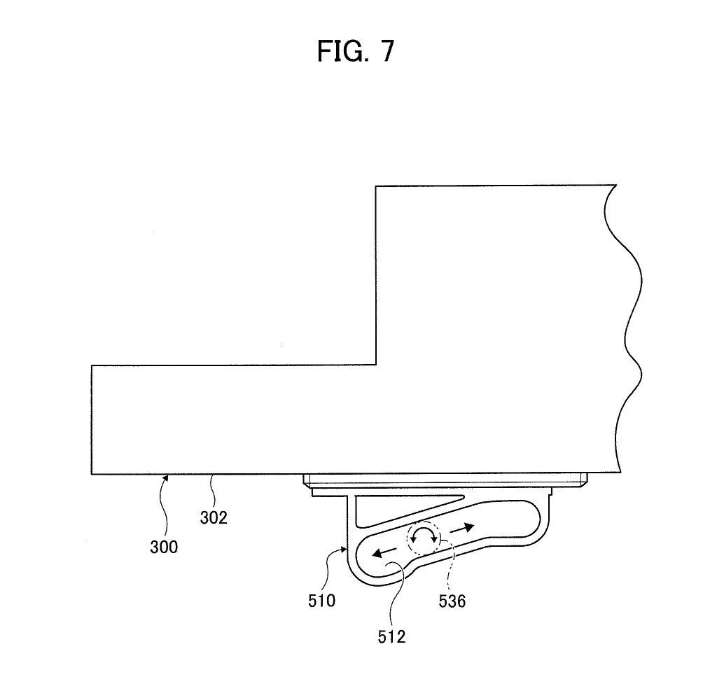

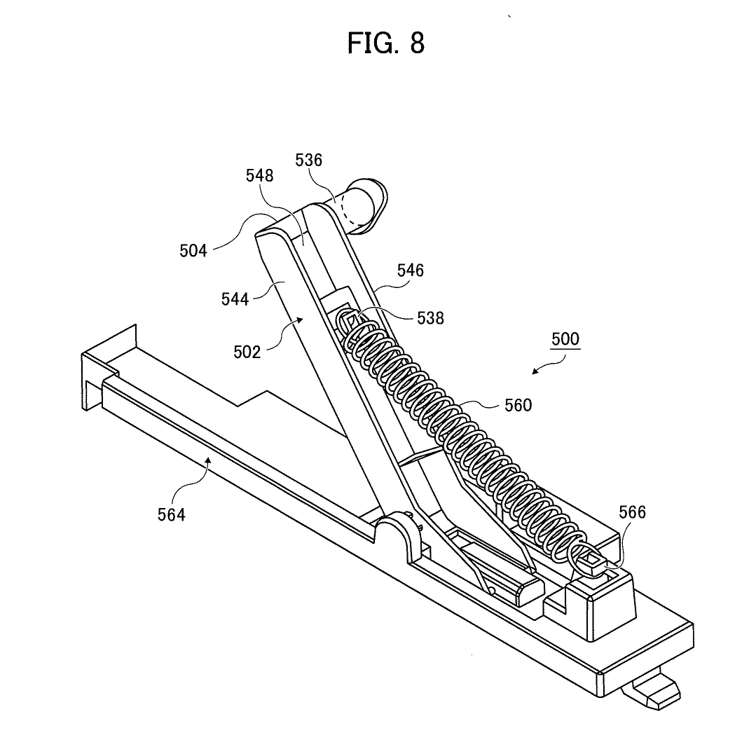

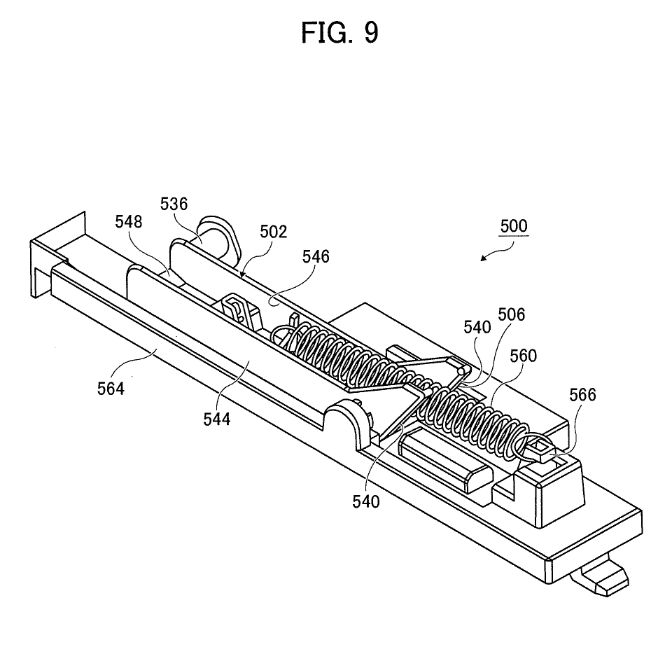

FIG. 7 shows the guide member 510. As shown in FIG. 7, a guide hole 512 is formed in the guide member 510. A protrusion 536 (see FIGS. 8 and 9) to be described later formed on the arm member 502 (see FIG. 2) is inserted into the guide hole 512. The guide member 510 supports the arm member 502 in such a manner that the protrusion 536 is rotatable and movable within the guide hole 512. In this manner, the protrusion 536 moves within the guide hole 512, and thus the movement of the arm member 502 is guided by the guide member 510.

The guide member 510 is attached to the document reading device 300. Thus, in this image forming apparatus 10, as compared with the case where a guide member for guiding the arm member 502 is provided on the image forming apparatus main body 30, the space S on the ejection portion 600 is increased, thereby reducing obstacles at the time of inserting, for example, the right hand into the space S.

FIGS. 8 and 9 show the shock absorber 500. As described above, the shock absorber 500 includes the arm member 502 and the coil spring 560, and further includes a support member 564 that supports the arm member 502 in such a manner as to allow the arm member 502 to pivotally move.

The arm member 502 includes two side walls 544 and 546 facing each other, and a connecting portion 548 that is nearly perpendicular to the side walls 544 and 546 and connects the side walls 544 and 546. Also, the arm member 502 includes the protrusion 536 to be inserted into the guide hole 512 (see FIG. 7) of the guide member 510. The protrusion 536 is formed on one end 504 of arm member 502 in a manner protruding from right to left. Furthermore, the arm member 502 includes a spring mounting portion 538 for mounting one end of the coil spring 560.

Moreover, the arm member 502 includes straight portions 540 formed into a linear shape on the other end 506. The respective straight portions 540 are formed on the side walls 544 and 546. In a state shown in FIG. 8 in which the arm member 502 supports the document reading device 300 that is in an open state with respect to the image forming apparatus main body 30, the straight portions 540 are biased against an upper flat surface of the support member 564 by means of the coil spring 560, thereby causing the arm member 502 to rest. In this manner, the arm member 502 is adapted to support the document reading device 300 that is in an open state with respect to the image forming apparatus main body 30, and rest in such a state.

In a state in which the document reading device 300 is located in the second position corresponding to the state in which the space S is expanded and the open state with respect to the image forming apparatus main body 30, the arm member 502 is inclined in such a manner that the other end 506 is located at a position more distant than one end 504 from the front surface 38 that is a surface of the image forming apparatus main body 30 on the side thereof on which paper sheets are retrieved from the ejection portion 600 provided on the image forming apparatus main body 30 (see also FIG. 2). Therefore, in this image forming apparatus 10, as compared with a configuration in which the arm member 502 is inclined in such a manner that the other end 506 is located at a position closer than one end 504 to the front surface 38 that is a surface of the image forming apparatus main body 30 on the side thereof on which paper sheets are retrieved from the ejection portion 600 provided on the image forming apparatus main body 30, the space S on the ejection portion 600 is increased, thereby reducing obstacles at the time of inserting, for example, the right hand into the space S.

The support member 564 includes a spring mounting portion 566 for mounting the other end of the coil spring 560, and is mounted on the image forming apparatus main body 30 (see FIG. 1). In other words, the arm member 502 is mounted at the other end 506 to the image forming apparatus main body 30 through the support member 564.

The coil spring 560 is disposed on a side of the arm member 502 opposite the front surface 38 that is a surface of the image forming apparatus main body 30 on the side thereof on which paper sheets are retrieved from the ejection portion 600. Therefore, in this image forming apparatus 10, as compared with the case where the coil spring 560 is disposed on the same side of the arm member 502 as the front surface 38, the space S on the ejection portion 600 is increased, thereby reducing obstacles at the time of inserting, for example, the right hand into the space S.

As described above, the present invention can be applied to image forming apparatuses, such as copying machines, facsimile machines, and printers, and to opening/closing devices.

The foregoing description of an exemplary embodiment of the present invention has been provided for the purposes of illustration and description. It is not intended to be exhaustive or to limit the invention to the precise forms disclosed. Obviously, many modifications and variations will be apparent to practitioners skilled in the art. The exemplary embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image forming apparatus comprising:
an image forming apparatus main body;
an ejection portion that is provided on an upper surface of the image forming apparatus main body and receives a recording medium;
a structure that is disposed above the image forming apparatus main body, with a space formed between the structure and the ejection portion;
a mounting mechanism that mounts the structure on the image forming apparatus main body in such a manner as to allow the structure to pivotally move about a rotary shaft with respect to the image forming apparatus main body and to allow the structure to be movable between a first position at which the structure is supported from below by an upper surface of the image forming apparatus main body and a second position at which the space is expanded; and
a supporting member that supports from below the structure located in the second position and has one end mounted to the structure and another end mounted to the image forming apparatus main body, the image forming apparatus main body having a cutout continuous with the space, the cutout being formed in such a manner as to straddle a surface of the image forming apparatus main body on a side thereof on which the recording medium is retrieved from the ejection portion and a surface of the image forming apparatus main body on one side thereof in a direction of the rotary shaft, the other end of the supporting member being located at a position more distant than the one end from the surface of the image forming apparatus main body on the side thereof on which the recording medium is retrieved from the ejection portion, in a state in which the structure is located in the second position.

2. The image forming apparatus according to claim 1, further comprising a guide portion that guides the supporting member, wherein the guide portion is provided on the structure.

3. The image forming apparatus according to claim 1, further comprising a biasing member that urges the supporting member, wherein the biasing member is disposed on a side of the supporting member opposite a side thereof on which the recording medium is retrieved from the ejection portion.

4. The image forming apparatus according to claim 1, further comprising an operating portion that is used to operate the image forming apparatus, wherein the operating portion is provided on a side of the structure on which the cutout is provided in the direction of the rotary shaft.

5. An opening/closing device comprising:
a first structure;
an ejection portion that is provided on an upper surface of the first structure and receives an ejected object;
a second structure that is disposed above the first structure, with a space formed between the second structure and the ejection portion;
a mounting mechanism that mounts the second structure on the first structure in such a manner as to allow the second structure to pivotally move about a rotary shaft with respect to the first structure and to allow the second structure to be movable between a first position at which the second structure is supported from below by an upper surface of the first structure and a second position at which the space is expanded; and
a supporting member that supports from below the second structure located in the second position and has one end mounted to the second structure and another end mounted to the first structure, the first structure having a cutout continuous with the space, the cutout being formed in such a manner as to straddle a surface of the first structure on a side thereof on which the ejected object is retrieved from the ejection portion and a surface of the first structure on one side thereof in a direction of the rotary shaft, the other end of the supporting member being located at a position more distant than the one end from the surface of the first structure on the side thereof on which the ejected object is retrieved from the ejection portion, in a state in which the second structure is located in the second position.
